(19) United States
(12) Patent Application Publication
(10) Pub. No.: US 2005/0080456 A1
(43) Pub. Date: Apr. 14, 2005

(54) Teether

(76) Inventors: Peter Newton Sanbrook, Ringwood (AU); Rod Anthony Wiebenga, Kew (AU); Barbara Lerpiniere, Ringwood (AU)

Correspondence Address: MERCHANT & GOULD PC, P.O. BOX 2903, MINNEAPOLIS, MN, 55402-0903, US

(21) Appl. No.: 10/503,705

(22) PCT Filed: Feb. 5, 2003
(86) PCT No.: PCT/AU03/00116

(30) Foreign Application Priority Data
Feb. 5, 2002 (AU) PS 0322

(51) Int. Cl. A61J 17/00

(52) U.S. Cl. 606/235

(57) ABSTRACT

A teether comprising a mouth-engageable portion, a handle, and a shield, wherein the mouth-engageable portion is generally U-shaped so as to define upper and lower surfaces and outer ends, and dimensioned to be engageable between the upper and lower teeth of a user, which mouth-engageable portion is relatively thicker and at adjacent the outer ends and relatively thinner in a centre region generally midway between the outer ends adjacent to this shield.

### FIELD OF THE INVENTION

This invention relates generally to teethers and is concerned in different aspects with the soothing effect of teethers and with their mode of construction. The term “teether” embraces, for example, pacifiers and oral toys. The invention is described herein primarily in relation to pacifiers but it is emphasized that it has much wider application.

### BACKGROUND ART

Pacifiers have long been employed to provide infants with a soothing, sucking action, in some cases for the purposes of calming the infant and in others for countering the soreness and consequent irritability that occurs during teething. The conventional pacifier is intended to mimic a mother's nipple and typically comprises a three part structure of nipple, shield and handle. The three separate components have been assembled in a variety of ways.

Australian registered design 132236 and its US counterpart, design Pat. No. 39,0962, illustrate a pacifier in which the mouth-engageable portion is generally U-shaped and is shaped and sized so that it is engageable between the upper and lower teeth of an infant user. The mouth-engageable portion is of thickness which tapers from a relatively thicker centre region to relatively thinner, and narrower, rounded tips. A device of somewhat similar appearance but described as an orthodontic appliance is disclosed in U.S. Pat. No. 4,986,751. The upper and lower surfaces of the U-shaped mouth-engageable portion have depressions or troughs to accommodate the upper and lower teeth to correctly position the jaws antero-posteriorly. A variety of appliances of different sizes are illustrated and described, to suit children from around 12-18 months to 4-6 years old.

U.S. Pat. No. 5,334,218 discloses a combination teether having both a nipple and a U-shaped teething member of substantially uniform thickness and width.

It is an object of the present invention to provide an improved teether of the kind having a generally U-shaped mouth-engageable portion in a form that serves a conventional soothing function but in an orthodontically optimum manner. In another aspect, an object of the invention is to provide an improved construction of pacifier.

### SUMMARY OF THE INVENTION

In the first aspect, the invention involves a realisation that the U-shaped mouth-engaging portions of the aforedescribed appliances have a profile that does not reflect the typical teething sequence.

In this first aspect, the invention provides a teether comprising a mouth-engageable portion, means for holding the teether, and means to externally engage the lips of a user, wherein the mouth-engageable portion is generally U-shaped so as to define upper and lower surfaces and outer ends, and dimensioned to be engageable between the upper and lower teeth of a user, which mouth-engageable portion is relatively thicker at and adjacent said outer ends and relatively thinner in a centre region generally midway between said outer ends adjacent to the lips engageable means.

In an advantageous application, the teether is a pacifier having a handle as said holding means, and, between the handle and the mouth engageable portion, a shield as said lips engageable means.

In another application, the teether is an oral toy, eg. with a body in the shape of a familiar object providing said holding means and said lips engageable means.

Preferably, the generally U-shaped mouth-engageable portion is also of a width that decreases away from said outer ends.

Advantageously, the upper and/or lower surfaces of the mouth-engageable portion are formed with one or more shallow depressions to receive a film of teething gel. These upper and/or lower surfaces may include a textured surface, eg a multiplicity of small protuberances, to enhance the soothing action of the pacifier. The textured surface may also assist in retaining a film of teething gel.

In a preferred mode of construction, the mouth-engageable portion and the handle are provided as a unitary piece, typically a unitary moulding in which the handle and the mouth-engageable portion are linked by a web or other bridging portion that extends through an opening in the shield.

Generally, in a second aspect, the invention provides a pacifier comprising a mouth-engageable portion, holding means and, between the handle and the mouth-engageable portion, means to externally engage the lips of a user, wherein the mouth-engageable portion is dimensioned to be engageable between the upper and lower teeth of a user. The handle and the mouth-engageable portion are formed as a unitary piece, eg a unitary moulding, in which the handle and the mouth-engageable portion are linked by a web or other bridging portion that extends through an opening in the lips engageable portions. The mouth-engageable portion and said holding means include opposed flanges about said web or other bridging portion, and said lips engageable means is accommodated between said flanges. The separation of the flanges in a relaxed state of the unitary piece in the absence of the lips engageable means is less than their separation with the lips engageable means in place, whereby to apply tension to the unitary piece and to thereby increase the stiffness of said mouth-engageable portion relative to said lips engageable means.

The handle is preferably a ring and is advantageously in a plane that extends at a substantial angle, eg between 30 and 600 and preferably about 45°, to a centre plane of the mouth-engageable portion.

The material of the mouth-engageable portion may conveniently be, for example, a medical grade silicone or a medically safe flexible polymer, eg pvc.

The invention further provides a pacifier segment comprising a mouth-engageable portion and holding means, wherein the mouth-engageable portion is generally U-shaped so as to define upper and lower surfaces and outer ends, dimensioned to be engageable between the upper and lower teeth of a user, wherein said handle and said mouth-engageable portion are formed as a unitary piece, eg a unitary moulding, in which the handle and the mouth-engageable portion are linked by a web or other bridging portion that, in an assembled pacifier, extends through an opening in the shield, and wherein said mouth-engageable portion is relatively thicker at and adjacent said outer ends and relatively thinner in a centre region generally midway between said outer ends.

### BRIEF DESCRIPTION OF THE DRAWINGS

The invention will now be further described, by way of example only, with reference to the accompanying drawings, in which:

FIG. 1 is a plan view of an infant's pacifier according to an embodiment of the invention;

FIGS. 2 is a view similar to FIG. 1, but of the one-piece moulding without the shield in place;

FIG. 3 is a side elevation corresponding to FIG. 1;

FIG. 4 is a front elevation;

FIG. 5 is a perspective view corresponding to FIG. 1;

FIG. 6 is a perspective view corresponding to FIG. 4;

FIG. 7 is a plan view of an infant's pacifier according to a second embodiment of the invention;

FIG. 8 is a front elevation corresponding to FIG. 7;

FIG. 9 is a perspective view corresponding to FIG. 8;

FIG. 10 is a plan view of an infant's pacifier according to a third embodiment of the invention;

FIG. 11 is a front elevation corresponding to FIG. 10; and

FIG. 12 is a perspective view corresponding to FIG. 11.

### DESCRIPTION OF EMBODIMENTS

The illustrated pacifier 10 is primarily suitable for use by an infant between the ages of approximately six months and fourteen months of age. Pacifier 10 includes a generally U-shaped mouth-engageable portion 20, a handle 30, and, between the handle 30 and portion 20, a shield 40. Mouth engageable portion 20 and handle 30 are formed as a unitary moulding 12 that extends through an opening in the shield 40. This moulding is formed in a suitable medical grade silicone or medically safe polymer.

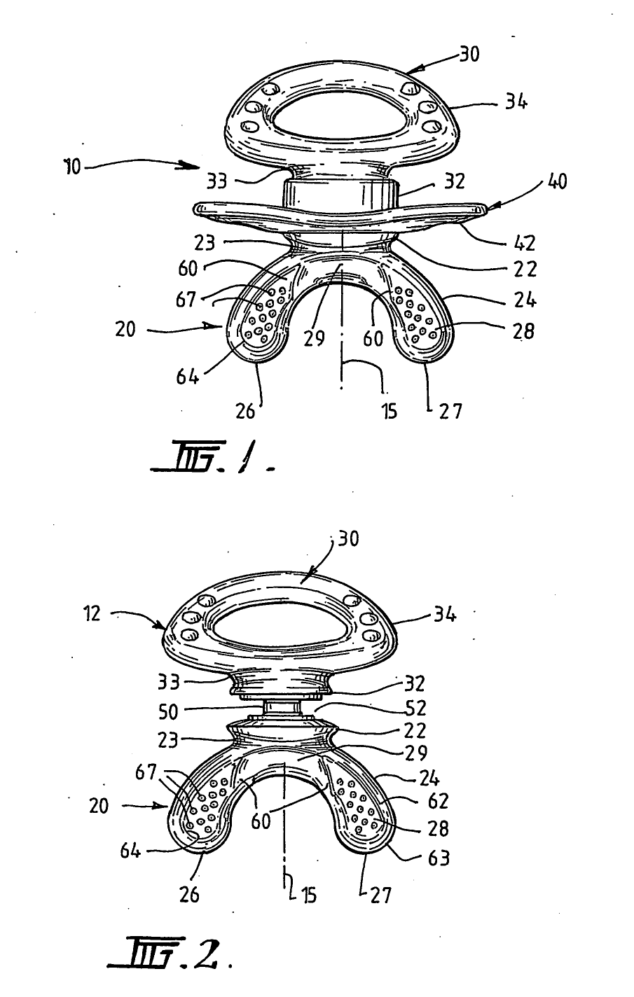

Generally U-shaped mouth-engaging portion 20 has somewhat of the shape of a wing nut in plan (FIG. 1), having a central flange structure 22 of generally oval shape in elevation, linked to the main body 24 of the mouth-engaging portion by a neck portion 23 oriented along the longitudinal axis of the flange structure 22. Flange structure 22 is opposed to and spaced from a complementary flange structure 32, of similar form and slightly smaller dimensions than flange structure 22, integrally linked in turn by neck portion 33 to the main body of the handle comprising a ring 34. Ring 34 is an elliptical toroid, ie. it is somewhat flattened towards the flanges, as best seen in FIG. 2.

Flange structures 22, 32 are joined at their centres by a web or bridging portion 50 which thereby integrally joins the mouth-engaging portion 20 and the handle 30. A generally annular cavity 52 is defined about web 50 between flange structures 22, 32 to accommodate shield 40. It is web 50 that extends through the opening in shield 40.

Shield 40 is best seen in FIGS. 1 and 6. It is of thin, slightly elongate, slightly convex/concave form having a profile somewhat akin to a symmetrical peanut. In situ, its slightly convex rear face 42 bears against the lips of a user in the usual fashion.

Mouth engageable portion 20 is, as has been stated, generally U-shaped and is symmetrical about the normal axis 15 of flange structures 22, 32 and web 50. It defines upper and lower surfaces 62, 63 and outer curved or semi-circular ends 26, 27, and is dimensioned to be engageable between the upper and lower gums or teeth of a user ie. with the U-shape aligned along and in register with the line of the gums. Portion 20 is of such a shape or profile that it is narrowest, with respect to the outer face 25 of flange structure 22, on axis 15 at the centre point of the mouth-engaging portion. The width increases steadily to cross-section 28 of maximum width defining a diametral plane of each of the semi-circular ends 26, 27. The thickness of mouth-engageable portion 20 is also relatively greatest at and in the vicinity of cross-sections 28, but diminishes inwardly, most sharply in regions 60 generally midway between the aforesaid cross-sections 28 and the cross-section at axis 15, so that there is a centre region 29 which is relatively thinner, typically about a third to half the thickness at the cross-sections 28.

The tapered thickness of mouth-engaging portion 20 allows the centre region 29 to accommodate the protruding front or central incisors of the deciduous teeth after they have erupted while allowing the gums at the sides of the mouth to contact the thicker end regions for chewing prior to and during eruption of the canines and the deciduous molars. The centre region may optionally be shaped to additionally accommodate the lateral incisors as well as the central incisors.

An initial difficulty with the illustrated profile of the mouth-engaging portion 20 is that the thinning of the centre region 29 adversely diminished the stiffness of the mouth-engageable portion relative to shield 40. This problem was overcome in accordance with the second aspect of the invention by arranging for the separation of flange structures 22, 32 to be finitely less than the thickness of the shield 40 so that the web 50 and the moulding as a whole is tensioned on axis 15 when the moulding is assembled with the shield in place in annular cavity 52. This tensioning has the effect of enhancing the stiffness of the mouth-engageable portion relative to shield 40.

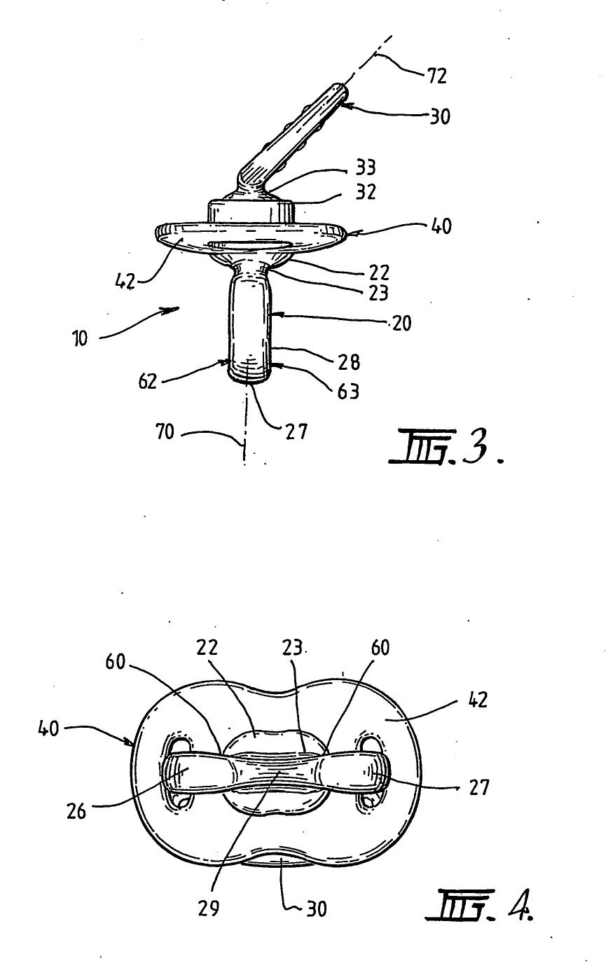

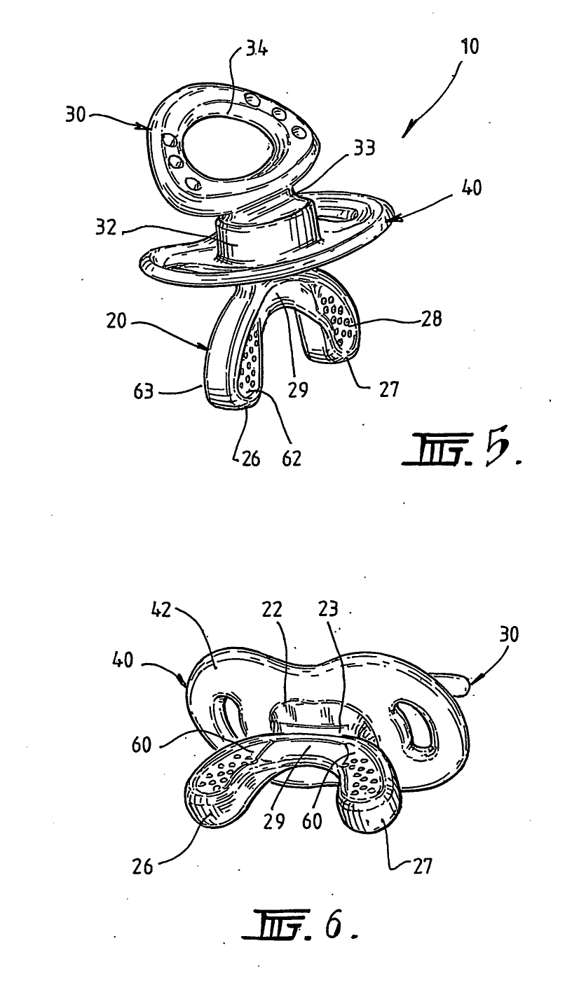

It will be seen from FIG. 3 in particular that mouth-engageable portion 20 and handle 30 are of a generally flat structure so as to define respective centre planes 70, 72. However, these planes are substantially mutually oriented, preferably at about 45°. The arrangement is in keeping with Australian Standard AS2432 which governs the size and radial arrangement of the handles of pacifiers. The one-piece moulding construction allows the angularly oriented handle to act to a degree as shock absorber if the infant falls over with the pacifier in his or her mouth.

To further enhance the soothing qualities of the mouth-engageable portion 20, it is optimally provided with two additional features. Firstly, the top and bottom surfaces 62, 63 to either side of centre region 29 are provided with shallow depressions 64 which are adapted to maintain a film of a teething gel. In addition, these depressions have a textured surface in the form of multiple spaced small protrusions 67 which give the feel and appearance of a rough rather than smooth surface, whereby to assist in the soothing massaging of the gums of an infant who has placed the pacifier in its mouth.

FIGS. 7, 8 and 9 illustrate a second embodiment of pacifier 110 according to the invention. Like reference numerals are used, preceded by a 1, to denote features similar to the first embodiment.

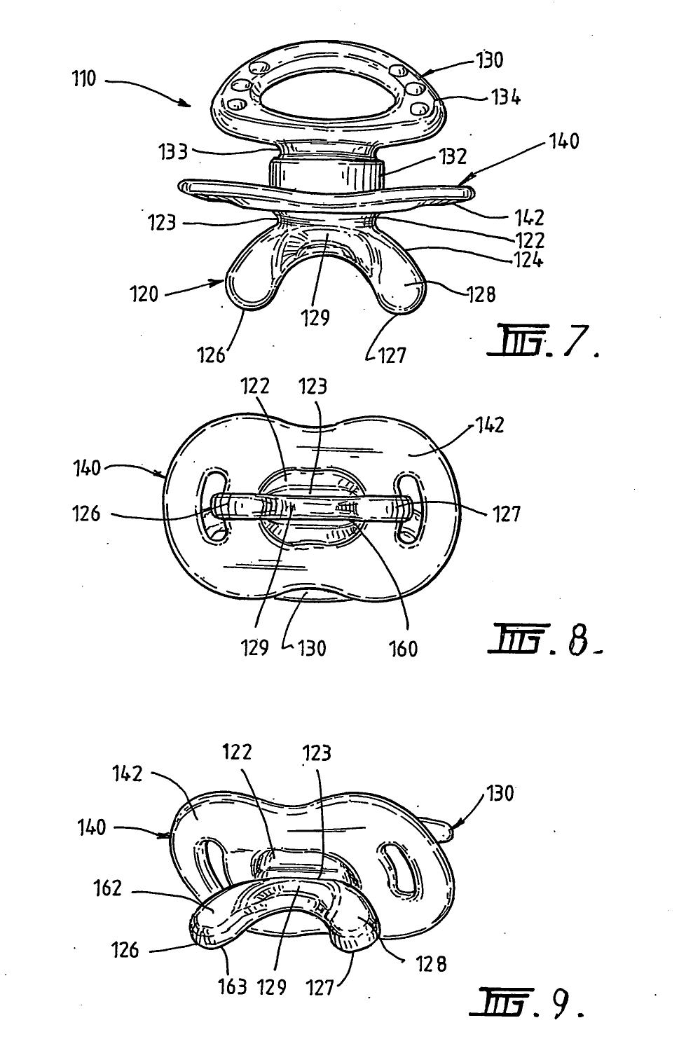

The pacifier 110 is primarily suitable for use by an infant under approximately six months of age. Accordingly, the mouth-engageable portion 120 is dimensioned for use by an infant under six months, with the length from the centre region 129 to the outer end 126,127 reduced relative to pacifier 10, as best shown in FIG. 7. The width at cross-section 128 is also less than pacifier 10, as is the diameter and thickness of the semi-circular outer ends 126, 127. As illustrated best in FIG. 8 the difference in thickness between centre region 129 and outer ends 126, 127 is not as great as in the first embodiment, as an infant under six months does not yet have protruding front incisors of the deciduous teeth, allowing the gums to contact the mouth-engageable portion at the centre region 129 as well as at the sides. In further alternative embodiments, this thickness variation is similar to the first embodiment or intermediate the two illustrated embodiments.

Pacifier 110 is depicted without shallow teething gel depressions 64 or protrusions 67, but these may of course be included in a modified form of the pacifier.

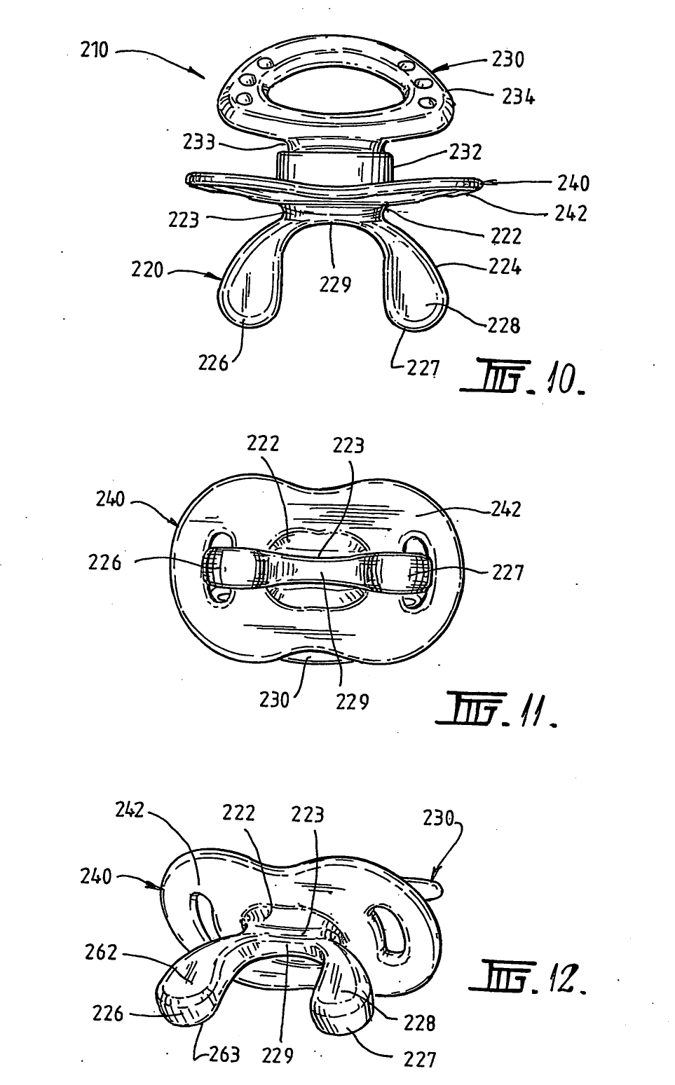

FIGS. 10, 11 and 12 illustrate a third embodiment of pacifier 210 according to the invention. Like reference numerals are used, preceded by a 2, to denote features similar to the first embodiment.

The pacifier 210 is primarily suitable for use by an infant over approximately fourteen months of age. The mouth-engageable portion is similarly dimensioned to the first embodiment, however the centre region has been pared back to a narrow strip 229, to allow front incisors to fully protrude. This embodiment allows the gums at the sides of the mouth to contact the thicker end regions for chewing during eruption of the remaining teeth. As with the second embodiment, the third embodiment is illustrated without shallow gel depressions or protrusions, however they may be included if desired.

It will be understood that the invention disclosed and defined in this specification extends to all alternative combinations of two or more of the individual features mentioned or evident from the text or drawings. All of these different combinations constitute various alternative aspects of the invention.

1-50. (canceled)

51. A teether comprising:
a mouth-engageable portion;
holding means; and
means to externally engage the lips of a user;
wherein said mouth-engageable portion is generally U-shaped so as to define upper and lower surfaces and outer ends, and dimensioned to be engageable between the upper and lower teeth of a user, said mouth-engageable portion is relatively thicker at and adjacent said outer ends and relatively thinner in a centre region generally midway between said outer ends adjacent to said lips engageable means.

52. A teether according to claim 51, wherein said holding means is a handle.

53. A teether according to claim 52, wherein said lips engageable means is a shield, located between said holding means and said mouth-engageable portion.

54. A teether according to claim 53, wherein said U-shaped mouth-engageable portion is of a width that decreases away from said outer ends.

55. A teether according to claim 51, wherein said U-shaped mouth-engageable portion is of a width that decreases away from said outer ends.

56. A teether according to claim 51, wherein said upper and/or lower surfaces of said mouth-engageable portion are formed with at least one shallow depression.

57. A teether according to claim 56, wherein said at least one shallow depression is for receiving a film of teething gel.

58. A teether according to claim 53, wherein said upper and/or lower surfaces of said mouth-engageable portion are formed with at least one shallow depression.

59. A teether according to claim 58, wherein said at least one shallow depression is for receiving a film of teething gel.

60. A teether according to claim 51, wherein said upper and/or lower surfaces of said mouth-engageable portion include a textured surface.

61. A teether according to claim 60, wherein said textured surface consists of a multiplicity of small protuberances.

62. A teether according to claim 53, wherein said upper and/or lower surfaces of said mouth-engageable portion include a textured surface.

63. A teether according to claim 60, wherein said textured surface consists of a multiplicity of small protuberances.

64. A teether according to claim 51, wherein said mouth-engageable portion and said holding means are provided as a unitary piece.

65. A teether according to claim 64, wherein said unitary piece is a unitary moulding in which said mouth-engageable portion and said holding means are linked by a web or other bridging portion that extends through an opening in said lips engageable means.

66. A teether according to claim 65, wherein said mouth-engageable portion and said holding means include opposed flanges about said web or other bridging portion, and said lips engageable means is accommodated between said flanges.

67. A teether according to claim 16, wherein the separation of said flanges in a relaxed state of said unitary piece in the absence of said lips engageable means is less than their separation with said lips engageable means in place, whereby to apply tension to the unitary piece and to thereby increase the stiffness of said mouth-engageable portion relative to said lips engageable means.

68. A teether according to claim 51, wherein said holding means is a ring.

69. A teether according to claim 68, wherein said ring is in a plane that extends at a substantial angle to a centre plane of said mouth-engageable portion.

70. A teether according to claim 69, wherein said angle is between 30° and 60°.

71. A teether according to claim 69 wherein said angle is 45°.

72. A teether according to claim 68, wherein said lips engageable means is a shield, located between said holding means and said mouth-engageable portion.

73. A teether according to claim 72, wherein said lips engageable means is a shield, located between said holding means and said mouth-engageable portion.

74. A teether according to claim 51, wherein said mouth-engageable portion is manufactured in a medical grade silicone.

75. A teether according to claim 5 1, wherein said mouth-engageable portion is manufactured in a medically safe flexible polymer.

76. A teether according to claim 75, wherein said medically safe flexible polymer is pvc.

77. A pacifier comprising:
a mouth-engageable portion;
holding means; and
means to externally engage the lips of a user;
wherein said lips engageable means is located between said mouth-engageable portion and said handle and said mouth-engageable portion is dimensioned to be engageable between the upper and lower teeth of a user,
wherein said holding means and said mouth-engageable portion are formed as a unitary piece, in which said holding means and said mouth-engageable portion are linked by a web or other bridging portion that extends through an opening in said lips engageable means; and
wherein said mouth-engageable portion and said holding means include opposed flanges about said web or other bridging portion, and said lips engageable means is accommodated between said flanges, the separation of said flanges in a relaxed state of said unitary piece in the absence of said lips engageable means being less than their separation with said lips engageable means in place, whereby to apply tension to the unitary piece and to thereby increase the stiffness of said mouth-engageable portion relative to said lips engageable means.

78. A pacifier according to claim 77, wherein said holding means is a handle.

79. A pacifier according to claim 78, wherein said lips engageable means is a shield, located between said holding means and said mouth- engageable portion.

80. A pacifier according to claim 51 wherein said mouth-engageable portion is generally U-shaped so as to define upper and lower surfaces and outer ends.

81. A pacifier according to claim 80, wherein said U-shaped mouth-engageable portion is of a width that decreases away from said outer ends.

82. A pacifier according to claim 80, wherein said upper and/or lower surfaces of said mouth-engageable portion are formed with at least one shallow depression.

83. A pacifier according to claim 82, wherein said at least one shallow depression is for receiving a film of teething gel.

84. A pacifier according to claim 77, wherein said upper and/or lower surfaces of said mouth-engageable portion include a textured surface.

85. A pacifier according to claim 84, wherein said textured surface consists of a multiplicity of small protuberances.

86. A pacifier according to claim 77, wherein said holding means is a ring.

87. A pacifier according to claim 86, wherein said ring is in a plane that extends at a substantial angle to a centre plane of said mouth-engageable portion.

88. A pacifier according to claim 87, wherein said angle is between 30° and 60°.

89. A pacifier according to claim 87 wherein said angle is 45°.

90. A pacifier according to claim 77, wherein said mouth-engageable portion is manufactured in a medical grade silicone.

91. A pacifier according to claim 77, wherein said mouth-engageable portion is manufactured in a medically safe flexible polymer.

92. A pacifier according to claim 91, wherein said medically safe flexible polymer is pvc.

93. A pacifier segment comprising:
a mouth-engageable portion; and
holding means;
wherein said mouth-engageable portion is generally U-shaped so as to define upper and lower surfaces and outer ends, dimensioned to be engageable between the upper and lower teeth of a user, wherein said holding means and said mouth-engageable portion are formed as a unitary piece, in which said holding portions are linked by a web or other bridging portion, and wherein said mouth-engageable portion is relatively thicker at and adjacent said outer ends and relatively thinner in a centre region generally midway between said outer ends.

94. A pacifier segment according to claim 93, wherein said holding means is a handle.

95. A pacifier segment according to claim 94, wherein said U-shaped mouth-engageable portion is of a width that decreases away from said outer ends.

96. A pacifier segment according to any one of claim 93, wherein said upper and/or lower surfaces of said mouth-engageable portion are formed with at least one shallow depression.

97. A pacifier segment according to claim 96, wherein said at least one shallow depression is for receiving a film of teething gel.

98. A pacifier segment according to any one of claim 93, wherein said upper and/or lower surfaces of said mouth-engageable portion include a textured surface.

99. A pacifier segment according to claim 98, wherein said textured surface consists of a multiplicity of small protuberances.

100. A pacifier segment according to any one of claim 93, wherein said holding means is a ring.

101. A pacifier segment according to claim 100, wherein said ring is in a plane that extends at a substantial angle to a centre plane of said mouth-engageable portion.

102. A pacifier segment according to claim 101, wherein said angle is between 30° and 60°.

103. A pacifier segment according to claim 101 wherein said angle is 45°.

104. A pacifier segment according to any one of claim 93, wherein said mouth-engageable portion is manufactured in a medical grade silicone.

105. A pacifier segment according to any one of claim 93, wherein said mouth-engageable portion is manufactured in a medically safe flexible polymer.

106. A pacifier segment according to claim 105, wherein said medically safe flexible polymer is pvc.
